(19) United States
(12) Patent Application Publication
(10) Pub. No.: US 2022/0071439 A1
(43) Pub. Date: Mar. 10, 2022

(54) A SYSTEM AND METHOD FOR HEATING AND FROTHING A BEVERAGE

(71) Applicant: Koninklijke Douwe Egberts B.V., Utrecht (NL)

(72) Inventors: Andrew Charles Bentley, Banbury (GB); Harrison Lloyd Woodall, Banbury (GB); Nicholas Andrew Hansen, Banbury (GB)

(21) Appl. No.: 17/299,246

(22) PCT Filed: Dec. 20, 2019
(86) PCT No.: PCT/EP2019/086524

§ 371 Date: Jun. 2, 2021

(30) Foreign Application Priority Data
Dec. 24, 2018 (GB) 1821199.5

(51) Int. Cl. A47J 31/44; A47J 31/52; A47J 31/46

(52) U.S. Cl. CPC A47J 31/4489; A47J 31/461; A47J 31/52; A47J 31/4403

(57) ABSTRACT

A system for heating and frothing a beverage includes a device for preparing a beverage and a wand (12). The device has a wand holder (31) in which the wand is removably mountable to hold the wand in an operative position and a steam nozzle (15) operably connectable with a source of steam. The steam nozzle (15) is movable between a wand insertion position spaced from the wand holder to permit the wand to be inserted into or removed from the wand holder and a wand engagement position in which it operatively engages with an inlet end of the wand. The device has an actuator arrangement (60) operative to move the steam nozzle between said wand insertion and wand engagement positions and a control system for regulating actuation of the actuator arrangement.

### TECHNICAL FIELD OF THE INVENTION

The present invention relates to a system for heating and frothing a beverage, which system includes a device for preparing a beverage and a wand removably connectable to the device for introducing steam into a beverage and to a method of heating and frothing a beverage using the system.

### BACKGROUND TO THE INVENTION

Systems for heating and frothing a beverage in which a wand is used to introduce steam into the beverage to heat and froth the beverage is known. Air may also be introduced in the steam flow in order to aerate the beverage. The wand is an elongate member which in use extends into a cup or other container in which the beverage is to be heated and frothed. The wand has a steam conduit through which steam is passed from an inlet end of the wand connected with a steam supply to an outlet end configured to eject the steam into the beverage. Such wands are sometimes referred to as “froth wands” or “steam wands” but will be referred to herein simply as a “wand” or “wands”.

Such a system is known for example from US-A1-2003/0131735, in which the wand includes a generally tubular external sleeve and an inner core within the external sleeve. The inner core defines the steam conduit and the wand further includes a coupling mechanism to facilitate connection of the wand to a steam supply of a beverage preparation device. The coupling mechanism may include threads, clamps, grooves, quick connect mechanisms, or other suitable fasteners complementarily configured to connect with the steam supply and allow for de-coupling and re-coupling of the wand from the steam supply to facilitate maintenance and cleaning. The external sleeve may be removed for cleaning and repair. For example, the external sleeve may be removed after a beverage of one flavour is prepared, so as to minimize the risk of imparting an undesired flavour to a subsequently prepared beverage. In addition, several different external sleeves individually configured to accommodate specific functions may be interchangeably coupled to the wand core, thus diversifying the utility of the wand.

It is desirable from a hygienic point of view that the wand is de-coupled, cleaned and re-coupled after each use. However, in the system known from US-A1-2003/0131736, this process requires a lot of time making it somewhat impractical, with the result that users of the system frequently refrain from cleaning the wand after it has been used, which could lead to health risks. In addition, a contaminated wand may also contaminate the inside of the beverage preparation device, which internal contamination may be hard to remove.

To address some of the issues in the earlier system, we proposed in WO2017/003289 A2 a system in which the wand is disposable and in which it is easier and quicker to remove and replace the wand. The system includes a beverage preparation device having a steam nozzle connected with a steam source and a wand holder in which a wand is removably received. The wand holder is manually movable between an operational position in which the steam nozzle is in fluid communication with a steam inlet of the wand and a non-operative position in which the wand can be inserted into or removed from the wand holder. In this arrangement, a used wand can be quickly and easily removed from the device by moving the wand holder to the non-operative position. The used wand can be discarded and replaced by a new wand.

The provision of disposable wands enables the system to be used in a very hygienic manner, while at the same time reducing the time required to change the wand since cleaning of a used wand can be dispensed with. Whilst this is an improvement on the system disclosed in US-A1-2003/0131735, there is an ongoing need to develop arrangements for mounting and de-mounting a wand to a beverage preparation device which are simpler and more intuitive from an end user's perspective.

It is an objective of the present invention to address some or all of the drawbacks and/or limitations of the prior art.

It is a further objective of the present invention to provide an alternative system for heating and frothing a beverage comprising an arrangement for removably mounting a wand to a beverage preparation device and operatively connecting the wand with a source of steam that is simpler to use.

It is a still further objective of the present invention to provide an alternative method of for heating and frothing a beverage using a system comprising an arrangement for removably mounting a wand to a beverage preparation device and operatively connecting the wand with a source of steam that is simpler to use.

### SUMMARY OF THE INVENTION

Aspects of the invention relate to a system and method for heating and frothing a beverage.

According to a first aspect of the invention, there is provided a system for heating and frothing a beverage, said system comprising a device for preparing a beverage and a wand removably mountable to the device, the device having a wand holder in which the wand is removably mountable to hold the wand in an operative position and a steam nozzle operably connectable with a source of steam, wherein the steam nozzle is movable between a wand insertion position in which it is spaced from the wand holder to permit the wand to be inserted into or removed from the wand holder and a wand engagement position in which it operatively engages with an inlet end of the wand when the wand is mounted in the wand holder in the operative position, the device including an actuator arrangement operative to move the steam nozzle between said wand insertion and wand engagement positions and a control system for regulating actuation of the actuator arrangement.

The device may be a coffee machine.

In an embodiment, the steam nozzle is mounted in a carrier assembly which is movable between a home position and a steam injection position, wherein the steam nozzle is held in the wand insertion position when the carrier assembly is in the home position and the steam nozzle adopts the wand engagement position when the carrier assembly is in the steam injection position and a wand is mounted in the wand holder in the operative position.

In an embodiment, the steam nozzle is mounted for movement relative to the carrier assembly between first and second positions and is resiliently biased to the first position, the arrangement being configured such that, in use with the wand held in the wand holder, the steam nozzle engages the wand before the carrier assembly reaches the end of its travel from the home position to the stream injection position, continued movement of the carrier assembly to the steam injection position resulting in displacement of the steam nozzle relative to the carrier assembly from the first position to the second position against the resilient bias force. The arrangement may be configured such that the resilient bias holds the steam nozzle in engagement with the wand with a predetermined force in use. The device may have a sensor arrangement for detecting displacement of the steam nozzle from the first position to the second position when the carrier assembly is in the steam injection position. The sensor arrangement may comprise one or more Hall effect sensors

In an embodiment, the carrier assembly is constrained to move in a linear direction between said home and steam injection positions. The carrier assembly may be constrained to move exclusively in a vertical linear direction. In an embodiment, the wand defines a steam inlet orifice concentric about an axis, the carrier assembly being constrained to move in a linear direction parallel to the direction of said axis when the wand is mounted in the wand holder in the operative position. The nozzle may define an outlet region concentric about an axis which is co-incident with the axis of the steam inlet orifice of the wand when the wand is held in the wand holder in the operative position. Said axes may be vertical.

The actuator arrangement may comprise an electronic actuator. In an embodiment, the electronic actuator arrangement comprises an electric motor operatively connected with the carrier assembly by a drive transmission system. The drive transmission system may include a mechanism for converting rotational output of the motor into linear movement of the carrier assembly such as a rack and pinion mechanism or a cam drive arrangement.

The control system may comprise an electronic control system. The electronic control system may be programmable.

The wand holder may be mounted stationarily in the device. The wand holder may be part of a wand attachment unit and may comprise a pair of spring loaded jaws for holding the wand in said operative position. The wand attachment unit may further comprise the carrier assembly mounted in the unit for movement relative to the jaws between said home and steam injection positions.

The nozzle has a steam outlet and the wand a steam inlet, wherein the steam outlet of the nozzle is fluidly connected with the steam inlet of the wand when the nozzle is operatively engaged with the wand. A seal may be provided on at least one of the nozzle and the wand to form a seal between them when the nozzle is operatively engaged with the wand.

In an embodiment, the wand has an elongate main body and a flange extending radially outwardly from the main body, the wand holder being configured to support the flange from below when the wand is held in the wand holder. In this embodiment, the steam nozzle may be operative to clamp the wand flange to the wand holder when the wand is mounted in the wand holder in the operative position and the nozzle is in operative engagement with the wand. The flange may be located at or close to the inlet end of the wand.

Where the wand has an elongate body and a flange extending radially outwardly from the body, the wand holder may comprise a pair of jaws movable between a closed position and an open position, the jaws in the closed position defining an aperture between themselves through which the main body of the wand can pass and an upwardly directed support surface at least partially surrounding the aperture for supporting the flange of the wand from below, the jaws in the open position being spaced apart sufficiently that the flange of the wand can pass between them. The jaws may be biased to the closed position. In an embodiment, the jaws have opposed first end regions located at an outer position accessible by a user and profiled such that, in use, a wand can be inserted into the wand holder by pressing the main body of the wand between the opposed first end regions to cause the jaws to open against the bias force sufficiently to allow the body of the wand to pass between the end regions to enter regions of the jaws that define the aperture. The jaws may be configured to close about the main body of the wand under action of the bias force once it has passed into the regions of the jaws that define the aperture, in use. The jaws may fully encircle the main body of the wand when in the closed position. The jaws may be pivotally mounted for movement between the closed and open positions.

In an embodiment, the device comprises a locking mechanism operative to lock the jaws in the closed position when the steam nozzle is in operative engagement with a wand mounted in the wand holder in the operative position. Where the steam nozzle is mounted in a carrier assembly, the locking mechanism may comprise a lock member which is operatively connected with, or an integral part of, the carrier assembly for movement to a locking position in which it locks the jaws in the closed position when the carrier assembly moves to the steam injection position. The lock member may be part of the carrier assembly and arranged to engage with the jaws to lock them in the closed position when the carrier assembly is in the steam injection position, the lock member being disengaged from the jaws when the carrier assembly is in the home position. The jaws may have opposed second end regions which are spaced apart in the closed position and each jaw may be mounted for pivotal movement between the closed and open positions about an axis located between the first and second end regions, said lock member locating between the jaws at a position between the second end regions and said axes to prevent the jaws pivoting from the closed position to the open position. The first end regions of the jaws may be outer or forward end regions accessible to a user of the device and the second end regions may be inner or rearward end regions.

In an embodiment, the device comprises a wand ejector for ejecting the wand from the wand holder. Where the wand holder comprises a pair of jaws movable between a closed position and an open position, the wand ejector may be operative to move the jaws from the closed position to the open position to eject the wand. In this case and where the device has a carrier assembly, the carrier assembly may be movable in a direction away from the wand holder beyond the home position to a wand ejection position, the wand ejector comprising a wand ejection member operatively connected with, or an integral part of, the carrier assembly such that movement of the carrier assembly from the home position to the wand ejection position causes the wand ejection member to engage the jaws and move them to the open position. The wand ejection member may have a neck portion extending downwardly with a wider head portion at its free lower end, the jaws defining a wand ejection recess between them through which the neck portion is a sliding fit, the arrangement being such that movement of the carrier assembly from the home position to the wand ejection position causes the head portion to be drawn between the jaws, the head portion forcing the jaws to move to the open position when engaged between the jaws.

The device may include a formation for catching the wand and retaining it in a non-operative position when the wand is ejected from the wand holder. The formation may comprise a member located below the wand holder which defines a slot through which the elongate main body of the wand is able to pass, the slot being dimensioned such that the flange of the wand is not able to pass through it. The slot may be open at a forward end to enable removal of the wand from the slot.

The device may have a valve for regulating the flow of steam from the steam source to an outlet of the steam nozzle. The system may be configured such that the valve is operative to permit steam to flow from the steam source to the outlet of the steam nozzle only when steam nozzle is in operative engagement with a wand mounted in the operative position in the wand holder.

The valve may be an electronically actuated valve operated under control of the control system. Where the steam nozzle is movably mounted in a carrier assembly and resiliently biased to a first position but moved to a second position through engagement with a wand in the operative position when the carrier assembly is in the steam injection position, the control system may be configured to actuate the valve to permit steam to flow from the steam source to the outlet of the steam nozzle in response to an input from a sensor arrangement indicative that the steam nozzle has been deflected to the second position and the carrier assembly is in the steam injection position.

In an embodiment where the steam nozzle is mounted in a carrier assembly and resiliently biased to a first position but moved to a second position through engagement with a wand in the operative position when the carrier assembly is in the steam injection position, the steam nozzle may be slidably mounted in a bore defined in a valve body forming part of the carrier assembly for movement between said first and second positions, the valve body defining an inlet port opening into the bore and fluidly connectable with the steam source, the nozzle defining a steam inlet and a steam outlet fluidly connected by a steam passage, the nozzle steam inlet opening into the bore, wherein the arrangement is configured such that the nozzle steam inlet is fluidly connected with the inlet port through the valve body bore when the steam nozzle is in the second position but is fluidly isolated from the inlet port when the steam nozzle is in the first position.

In an embodiment, the nozzle has a region with a diameter smaller than the internal diameter of the bore in the valve body, the nozzle steam inlet being defined in said smaller diameter region of the nozzle, the nozzle carrying a first seal located above the nozzle steam inlet and a second seal located below the nozzle steam inlet, each of the first and second seals slidably engaging a surface of the bore, the arrangement being configured such that when the nozzle is in said second position, the first seal locates above the inlet port and the second seal locates below the inlet port so that the nozzle steam inlet is fluidly connected with the inlet port through the bore between the first and second seals. The arrangement may also be configured such that when the steam nozzle is in the first position, one of the first and second seals engages the bore between the inlet port and the nozzle steam inlet such that the inlet port and the nozzle steam inlet are fluidly isolated from one another.

In an embodiment, the valve body also defines a venting outlet port which opens into the bore, the arrangement being configured such that the inlet port is fluidly connected with the venting outlet port through the bore when the nozzle is at an intermediate position between the first and second positions. In an embodiment, the venting port opens into the bore at a position above the inlet port and the nozzle carries a third seal for engagement with the bore which is located above the first seal, wherein the arrangement is configured such that in use when the nozzle is in the first position, the third seal locates between the inlet port and the venting port to fluidly isolate the inlet and venting ports from one another and when the nozzle is in said intermediate position, the third seal locates above the venting port and the first seal locates below the inlet port so that the inlet port and the venting port are fluidly connected through the bore between the first and third seals.

The valve body may further define a hot water outlet port which opens into the bore, the arrangement being configured such that the inlet port is fluidly connected with the hot water outlet port through the valve body bore when the nozzle is in the first position. The hot water outlet port may be fluidly connected with a brewing chamber of the device. In an embodiment, the hot water outlet port opens into the bore below the inlet port, the arrangement being configured such that in use:

a. when the nozzle is in the first position, the first seal locates below the hot water outlet port so that the inlet port and the hot water outlet port are fluidly connected through the bore between the first and third seals; and,

b. when the nozzle is in said intermediate position, the first seal is positioned between the inlet port and the hot water outlet port to fluidly isolate the inlet port from the hot water outlet port and the third seal locates above the venting port so that the inlet port is fluidly connected with the venting port through the bore between the first and third seals; and,

c. when the nozzle is in said second position, the second seal locates between the inlet port and the hot water outlet port so that the inlet port and the hot water outlet port are fluidly isolated from one another.

The seals may be separate items or some or all may be provided as sealing surfaces in a single integral seal member.

In accordance with a second aspect of the invention, there is provided a system for heating and frothing a beverage, said system comprising a device for preparing a beverage and a wand removably mountable to the device, the device having a wand holder in which the wand is removably mountable to hold the wand in an operative position and a steam nozzle operably connectable with a source of steam, wherein the steam nozzle is movable between a wand insertion position in which it is spaced from the wand holder to permit the wand to be inserted into or removed from the wand holder and a wand engagement position in which it operatively engages with an inlet end of the wand when the wand is mounted in the wand holder in the operative position, wherein the steam nozzle is mounted in a bore of a valve body for movement between a first position and a second position relative to the valve body, the arrangement being such that in use, the nozzle adopts the first position relative to the valve body when in the wand insertion position and the second position relative to the valve body when operatively engaged with a wand held in the wand holder in the operative position, the valve body defining an inlet port opening into the bore and fluidly connectable with the steam source, the nozzle defining a steam inlet and a steam outlet fluidly connected by a steam passage, the nozzle steam inlet opening into the bore, the arrangement being configured such that the nozzle steam inlet is fluidly connected with the inlet port through the bore when the steam nozzle is in the second position but is fluidly isolated from the inlet port when the steam nozzle is in the first position.

In an embodiment, the nozzle has a region with a diameter smaller than the internal diameter of the bore in the valve body, the nozzle steam inlet being defined in said smaller diameter region of the nozzle, the nozzle carrying a first seal located above the nozzle steam inlet and a second seal located below the nozzle steam inlet, each of the first and second seals slidably engaging a surface of the bore, the arrangement being configured such that when the nozzle is in said second position, the first seal locates above the inlet port and the second seal locates below the inlet port so that the nozzle steam inlet is fluidly connected with the inlet port through the bore between the first and second seals and when the nozzle is in the first position, one of the first and second seals engages the bore between the inlet port and the nozzle steam inlet such that the inlet port and the nozzle steam inlet are fluidly isolated from one another.

In an embodiment, the valve body further defines a venting outlet port which opens into the bore, the arrangement being configured such that the inlet port is fluidly connected with the venting outlet port through the bore when the nozzle is at an intermediate position between the first and second positions. In an embodiment, the venting port opens into the bore at a position spaced from the inlet port, the nozzle carrying a third seal slidingly engaging with the surface of the bore and which is spaced from the first and second seals, wherein the arrangement is configured such that in use when the nozzle is in the first position, the third seal locates between the inlet port and the venting port to fluidly isolate the inlet and venting ports from one another and when the nozzle is in said intermediate position, the third seal locates on one side of the venting port and the first and second seals locate on the opposite side of the inlet port from the venting port so that the inlet port and the venting port are fluidly connected through the bore. In an embodiment, the venting port opens into the bore at a position above the inlet port, the nozzle carrying a third seal slidingly engaging with the surface of the bore and which is located above the first seal, wherein the arrangement is configured such that in use when the nozzle is in the first position, the third seal locates between the inlet port and the venting port to fluidly isolate the inlet and venting ports from one another and when the nozzle is in said intermediate position, the third seal locates above the venting port and the first seal locates below the inlet port so that the inlet port and the venting port are fluidly connected through the bore.

The valve body may also define a hot water outlet port which opens into the bore, the arrangement being configured such that the inlet port is fluidly connected with the hot water outlet port through the valve body bore when the nozzle is in the first position. The hot water outlet port may be fluidly connected with a brewing chamber of the device. In an embodiment, the hot water outlet port opens into the bore at a position spaced from the inlet port, the arrangement being configured such that in use:

a. when the nozzle is in the first position, the first, second and third seals are positioned to define a flow path through the bore from the inlet port to the hot water outlet port, whilst fluidly isolating the inlet port from the nozzle steam inlet and the venting port; and

b. when the nozzle is in said intermediate position, the seals are positioned to define a flow path through the bore from the inlet port to the venting port, whilst fluidly isolating the inlet port from the nozzle steam inlet and the hot water outlet port; and,

c. when the nozzle is in said second position, the first and second seals locate either side of the inlet port such that a flow path is defined through the bore from the inlet port to the nozzle steam inlet between the first and second seals, the first and second seals being operative to fluidly isolate the inlet port from the venting port and the hot water outlet port.

In an embodiment, the venting port opens into the bore at a position above the inlet port and the hot water outlet port opens into the bore below the inlet port, the arrangement being configured such that in use:

a. when the nozzle is in the first position, the first seal locates below the hot water outlet port so that the inlet port and the hot water outlet port are fluidly connected through the bore between the first and third seals; and,

b. when the nozzle is in said intermediate position, the first seal is positioned between the inlet port and the hot water outlet port to fluidly isolate the inlet port from the hot water outlet port and the third seal locates above the venting port so that the inlet port is fluidly connected with the venting port through the bore between the first and third seals; and,

c. when the nozzle is in said second position, the second seal locates between the inlet port and the hot water outlet port so that the inlet port and the hot water outlet port are fluidly isolated from one another.

The seals may be separate items or some or all may be provided as part of a single integral member.

The system for heating and frothing a beverage according to the second aspect of the invention may comprise any of the features of the system for heating and frothing a beverage according to the first aspect of the invention as set out above.

In accordance with a third aspect of the invention, there is provided a method heating and frothing a beverage using the system according to either of the first and second aspects of the invention, the method comprising, with a wand mounted in the wand holder in the operative position, an outlet end of the wand projecting into a beverage, and the steam nozzle in the wand insertion position, advancing the steam nozzle from the wand insertion position to the wand engagement position to bring it into operative engagement with the wand, connecting the nozzle to the source of steam whilst it is operatively engaged with the wand such that steam is introduced into the beverage through the wand, disconnecting the steam nozzle from the source of steam once the heating and frothing process is complete and subsequently retracting the steam nozzle from the wand engagement position to disconnect it from the wand.

In the method according to the third aspect of the invention, movement of the steam nozzle may be carried out using the control system to control operation of the actuator arrangement. Where the steam nozzle is movable mounted in a carrier assembly, the step of advancing the steam nozzle from the wand insertion position to the wand engagement position to bring it into operative engagement with the wand may comprise moving the carrier assembly from the home position to the steam injection position and the step of subsequently retracting the steam nozzle from the wand engagement position to disconnect it from the wand may comprise moving the carrier assembly from the steam injection position back to the home position and/or beyond the home position.

The method may comprise ejecting the wand from the wand holder after the steam nozzle has been disconnected from the wand. Where the device has a formation for catching the wand and retaining it in a non-operative position when the wand is ejected from the wand holder, the method may comprise catching the wand in the formation after it has been ejected. Where the steam nozzle is mounted in a carrier assembly, the method may comprise retracting the carrier assembly to a wand ejection position beyond the home position and subsequently returning the carrier assembly to the home position.

### DETAILED DESCRIPTION OF THE INVENTION

In order that the invention may be more clearly understood embodiments thereof will now be described, by way of example only, with reference to the accompanying drawings, of which:

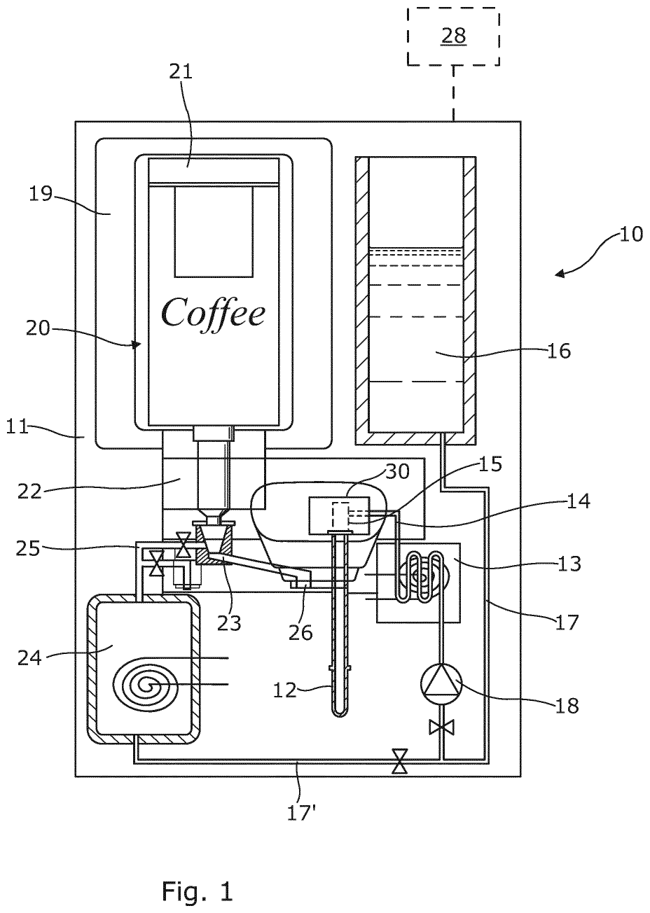

FIG. 1 is a schematic illustration of a first embodiment of a system for heating and frothing a beverage in accordance with an aspect of the invention, the system including a beverage preparation device and a removable wand.

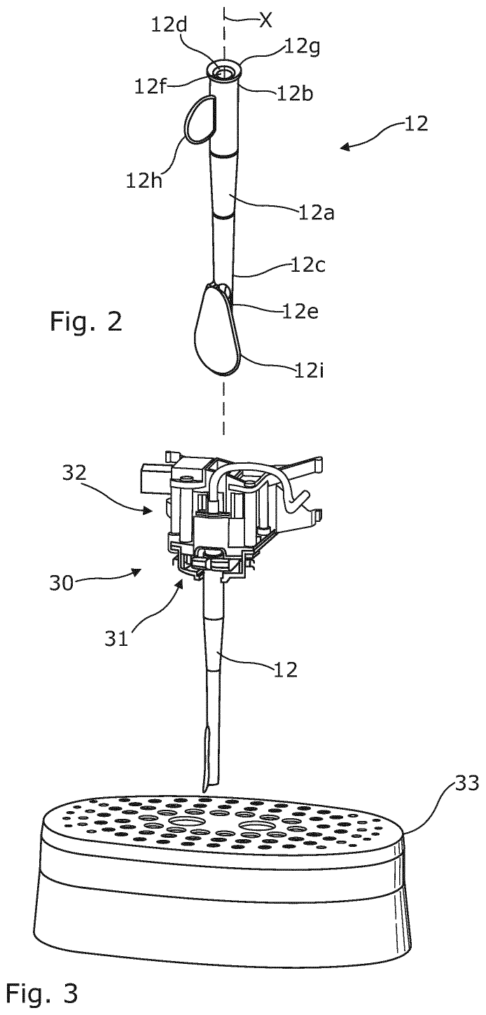

FIG. 2 is a perspective view of a wand for use in the system of FIG. 1.

FIG. 3 is a perspective view of part of the system of FIG. 1 including a first embodiment of a wand attachment unit forming part of the beverage preparation device, a wand, and a beverage container platform.

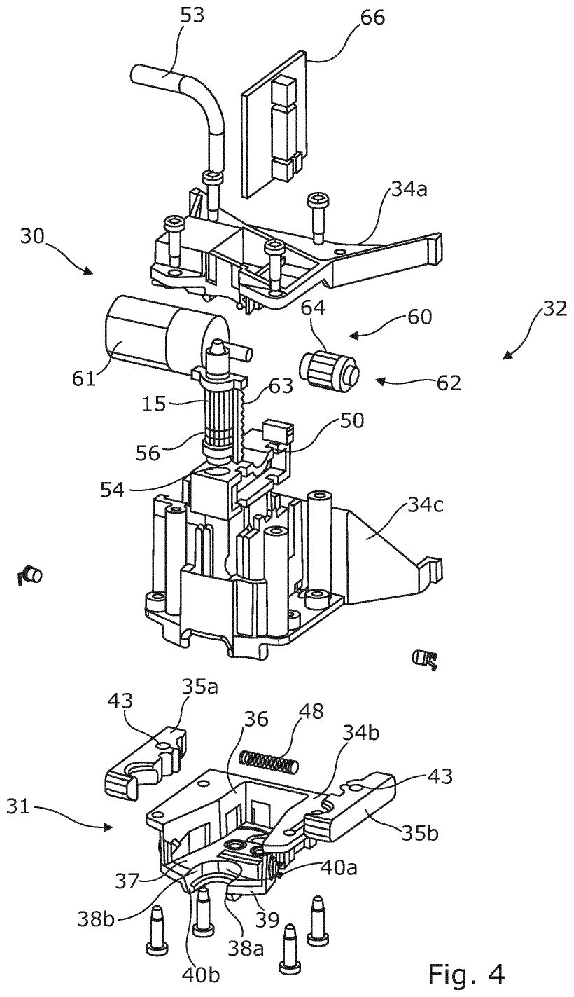

FIG. 4 is an exploded perspective view of the wand attachment unit in FIG. 3.

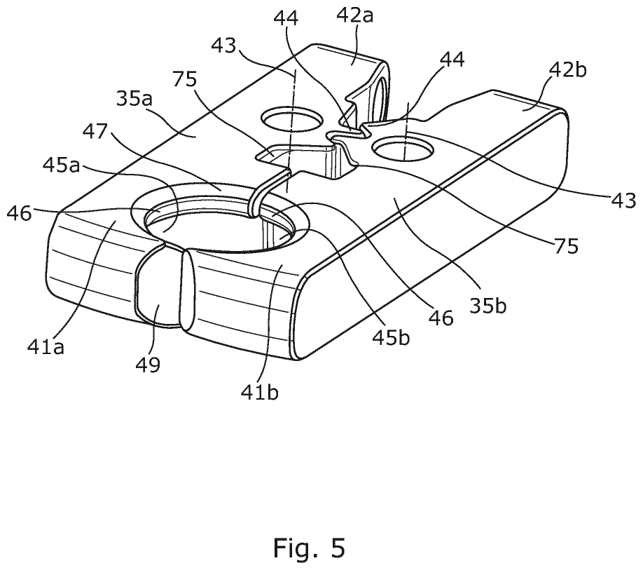

FIG. 5 is a perspective view on an enlarged scale of a pair of jaws forming part of a wand holder in the wand attachment unit in FIG. 3

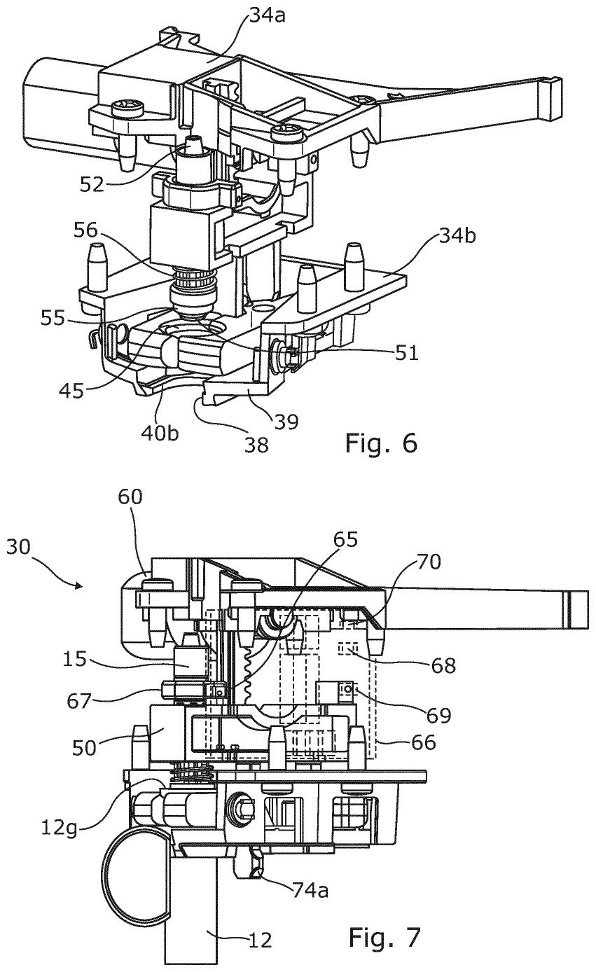

FIG. 6 is perspective view of the wand attachment unit in FIG. 3 with some parts omitted to show internal detail and with the wand attachment unit in a home configuration.

FIG. 7 is a further perspective view of the wand attachment unit in FIG. 3 but showing the wand attachment unit in a steam injection configuration and showing part of a wand mounted in an operative position in the unit.

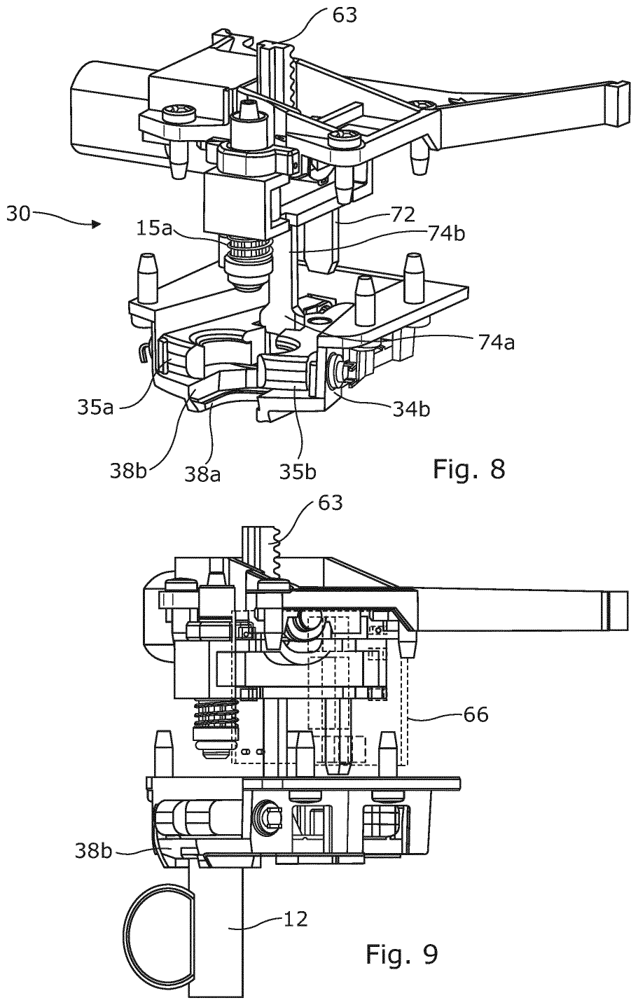

FIG. 8 is a view similar to that of FIG. 6 but showing the wand attachment unit in a wand ejection configuration.

FIG. 9 is a further perspective view of the wand attachment unit in FIG. 3 in a wand ejection configuration, illustrating how the wand is caught in a formation to be held in a non-operative position following ejection from a wand holder forming part of the wand attachment unit.

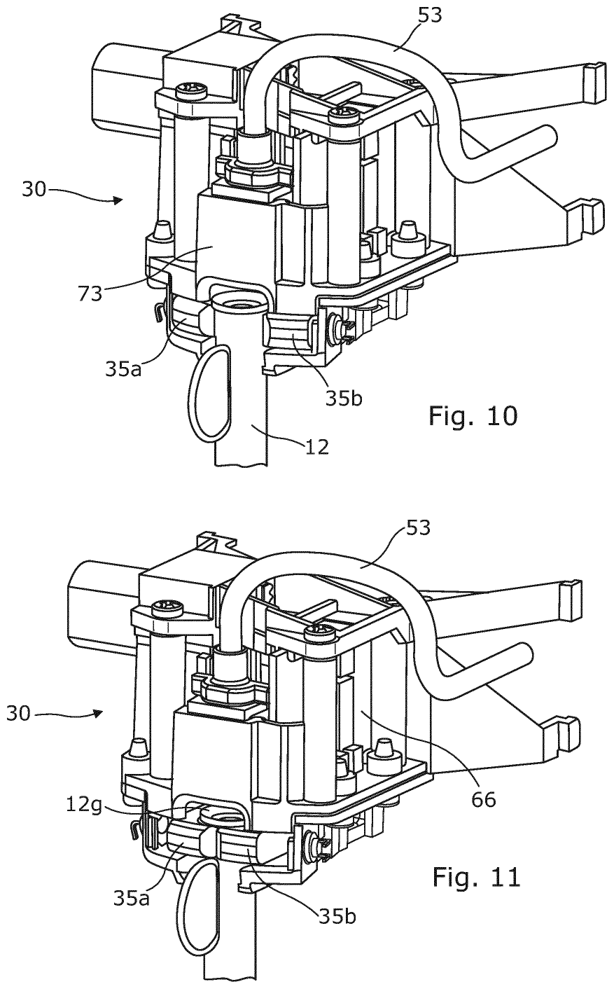

FIGS. 10 and 11 are a series of perspective views of the wand attachment unit in FIG. 3, illustrating how a wand is inserted into the unit in an operative position.

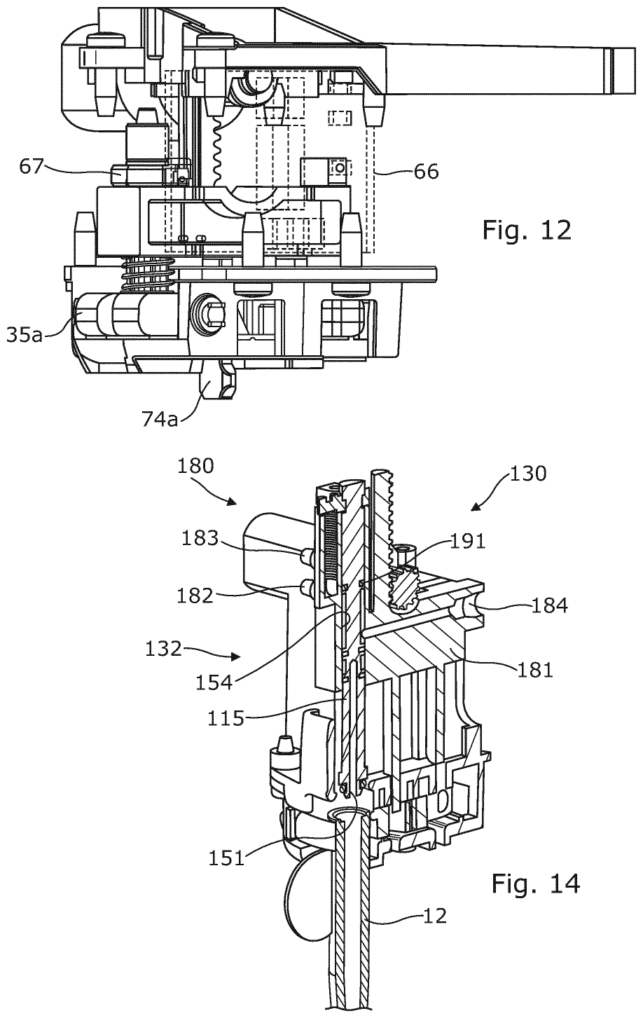

FIG. 12 is a perspective view of the wand attachment unit in FIG. 3 illustrating the unit after a steam nozzle carrier forming part of the unit has moved to a steam injection position but where no wand is mounted in an operative position.

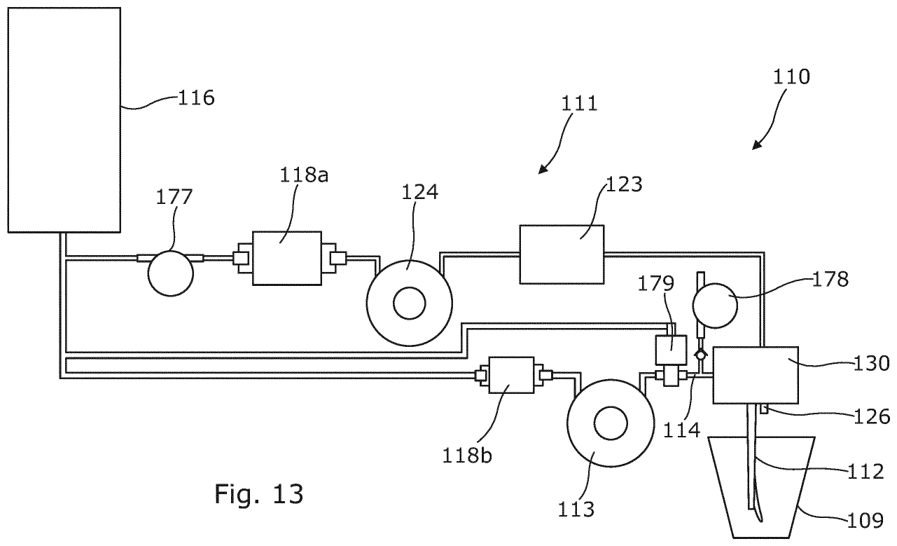

FIG. 13 is a schematic illustration showing the fluid circuit of a system for heating and frothing a beverage in accordance with a second embodiment, the system included a beverage preparation device and a removable wand.

FIGS. 14 to 16 are a series of cross-sectioned perspective views through a wand attachment unit forming part of the preparation device of the system of FIG. 13, in which the a wand attachment unit incorporates a mechanical fluid valve, the views showing the unit in different stages of operation.

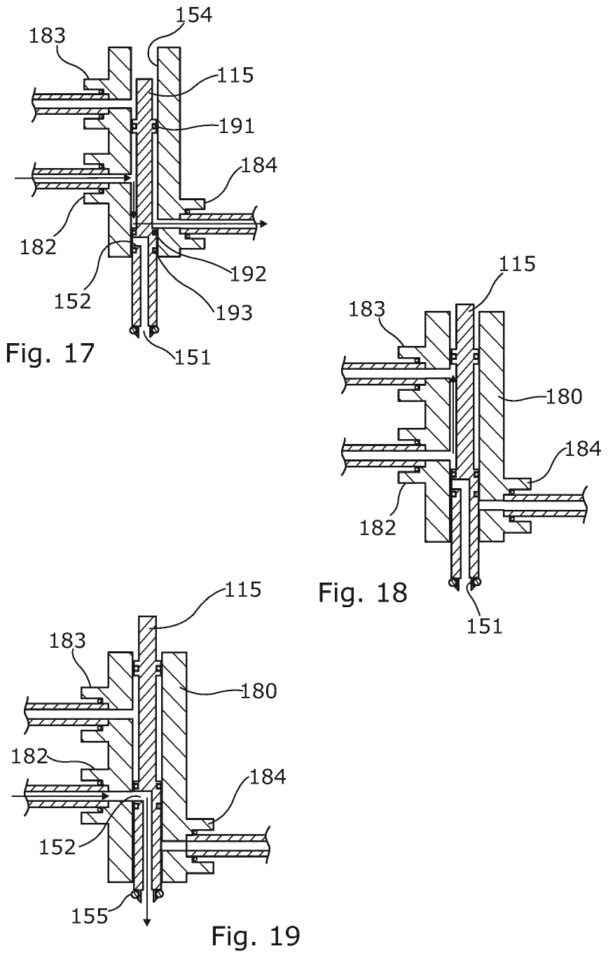

FIGS. 17 to 19 are a series of schematic representations of the valve incorporated into the wand attachment unit of FIGS. 14 to 16, illustrating how different flow paths through the valve.

In the following description, the same reference numerals but increased by 100 in each case will be used to identify features that are the same or which perform the same function in the various embodiments described.

FIG. 1 illustrates schematically a first embodiment of a system 10 for heating and frothing a beverage. The system includes a beverage preparation device 11 and a steam or frothing wand 12 which is removably mountable to the device. The system 10 is arranged to introduce steam through the wand 12 into a beverage in a cup or other container (not shown) in order to heat and/or froth the beverage in a known manner. The device 11 may be a coffee machine, such as an expresso machine, but the invention can be adapted for use with machines suitable for preparing beverages other than coffee.

The device 11 includes a steamer 13 for producing steam, for example a thermo-block, a steam conduit 14 for connecting the steamer to a steam nozzle 15. The device has a reservoir 16 for cold water, which cold water reservoir is connected to the steamer 13 via a cold water conduit 17 and a cold water pump 18.

In the embodiment shown in FIG. 1, the device 11 has a liquid coffee dispenser 19 for dispensing liquid coffee. The liquid coffee dispenser 19 includes a chamber 20 for receiving a package 21 of concentrated liquid coffee and a coffee dosing apparatus 22 for dosing an amount of concentrated liquid coffee from the package into a mixing chamber 23. Heated water is supplied from a water heater 24 via a water conduit 25 to the mixing chamber 23 to dilute the concentrated liquid coffee to a liquid coffee having a more consumable concentration. This liquid coffee can be dispensed into the beverage container from a liquid coffee outlet 26, which is located adjacent the wand. In the shown embodiment, the water heater 24 is supplied with cold water from the cold water reservoir 16 by means of the cold water conduit 17 and an extension 17′ thereof. In other embodiments, the water heater 24 can be supplied with water from a water source separate from the cold water reservoir 16.

The device 11 for preparing a beverage has an electronic control system (illustrated schematically at 28) for controlling various operations of the device. The control system 28 may comprise memory and at least one processor/CPU and is programed to control various functions of the device in accordance with defined algorithms. For example, the control system 28 is operationally connected to the steamer 13, to the cold water pump 18 and to the coffee dispenser 19 for controlling their operation. The control system 28 includes various sensor arrangements for providing inputs and feedback and a user interface through which a user can provide inputs to the control system 28 as is known in the art.

The present invention is concerned in particular with arrangements for removably mounting the wand 12 to the device 11 and for operatively coupling the steam nozzle 15 to the wand 12.

As best seen in FIG. 2, the wand 12 is an elongate member having a tubular main body 12a with a steam inlet end 12b and a steam outlet end 12c. A steam inlet 12d is defined at the steam inlet end 12b of the wand and at least one steam outlet 12e is defined at or towards the steam outlet end 12c. The wand also defines an internal steam conduit 12f which fluidly connects the steam inlet 12d and the at least one steam outlet 12e. The wand 12 has a longitudinal axis X and the steam inlet 12d is arranged at the steam inlet end 12b axially in-line with the longitudinal axis, the steam inlet 12d being a steam inlet orifice concentric about the longitudinal axis X of the wand. In use, the wand 12 is mounted to the device 11 in upright operative position with the steam inlet end 12b uppermost and the steam outlet end 12c lowermost. At or towards the steam inlet end, the wand 12 has an annular flange 12g which extends about the main body and projects radially outwardly of the outer surface of the main body 12a. The wand 12 has a handle attachment 12h, and a stirring formation 12i at the steam outlet end. The flange 12g need not be provided at the very upper end of the wand as shown but could be spaced downwardly from the upper end of the wand where the steam inlet 12d is provided.

The wand 12 can be of any suitable construction known in the art and could be a disposable wand such as any of those disclosed in WO 2017/003289 A2 or it could be a reusable wand. The system 10 may comprise a number of different wands adapted for different functionality. For example, the system could include wands of different lengths for use with different sized beverage containers and/or wands adapted to accommodate different functions. The wand may include air inlets through which air can be introduced into the steam conduit.

In the present embodiment, the wand body 12a is straight over its entire length. However, the wand could be kinked or otherwise shaped. Nevertheless, the steam inlet orifice 12d will generally be arranged concentric about an axis which extends vertically when mounted to the device in an operative position. The device 11 has a wand attachment unit (indicated generally at 30) located towards the front of the device 11. The wand attachment unit 30 has a wand holder or wand clamping arrangement (indicated generally at 31) for releasably holding a wand 12 in an operative position and a steam nozzle engagement mechanism (indicated generally at 32) for operatively coupling and decoupling the steam nozzle 15 with a wand 12 held in the operative position.

FIG. 3 shows the wand attachment unit 30 with a wand 12 mounted in the operative position above a beverage container platform 33 (also known as a cup station). In use a beverage container holding a beverage which is to be heated and/or frothed is mounted on the platform 33 with the wand 12 extending into the container so that the steam injection end is submerged in the beverage. The platform 33 is used with smaller beverage containers to position them closer to the wand 12 and the liquid coffee outlet 26. For lager beverage containers, the platform 33 can be omitted, in which case a longer wand 12 may be used. The system 10 may include a switch in the platform or other sensor arrangement for detecting when the platform 33 is being used to provide an input to the control system 28 indicative that a shorter wand is being used. The control system 28 is configured select an algorithm appropriate for delivering steam through a shorter or a longer wand dependant on whether or not an input is received indicating that the platform 33 is being used.

The wand attachment unit 30 includes a support frame 34 having an upper portion 34a, a lower portion 34b and a central portion 34c which locates between the upper and lower portions. The support frame 34 is fixedly mounted in the device 11. The central portion 34c of the support frame is omitted from FIGS. 6 to 9 and 12 to enable internal details of the wand attachment unit to be seen.

The lower portion 34b of the support frame 34 is part of the wand clamping arrangement 31 and houses a pair of jaws 35a, 35b which hold the wand 12 in the operative position in use. The lower portion 34b of the support frame forms a recessed housing 36 having a lower wall 37 on which the jaws 35a, 35b are mounted. The lower wall 37 defines a generally U shaped notch 38 along is front edge 39 which opens forwardly. A flange 40a extends downwardly from the edge of the notch and carries an inwardly directed lip 40b at is lower end. The lip 40b defines at its radially inner edge a slightly smaller U shaped notch portion 38a, so that the notch is stepped. The arrangement is configured so that the main body 12a of the wand 12 can pass through the smaller notch portion 38a defined by the lip 40b whilst the flange 12g of the wand cannot pass through the smaller notch portion but is receivable within the larger portion 38b of the notch above the lip 40b.

The jaws 35a, 35b are mounted to the lower wall 37 of the housing rearwardly of the notch 38. The jaws have opposing front end regions 41a, 41b which project above the notch 38 and opposite rear end regions 42a, 42b. The jaws 35a, 35b are each pivotally mounted to the lower wall for rotation about a vertical axis at a position 43 between their front and rear end regions. The jaws can pivot between a closed position as shown in FIG. 6, in which the front end regions 41a, 41b of the jaws abut one another, and an open position as shown in FIG. 8, in which the front end regions 41a, 41b of the jaws are spaced apart. The jaws 35a, 35b have inter-engaging gear formations 44 on their opposed inner faces to ensure the jaws pivot equally between open and closed positions.

Just rearwardly of their front ends, the jaws 35a, 35b each define an arcuate wand recess 45a, 45b, which together form a circular wand receiving aperture 45 through which the main body of the wand 12 can pass when the jaws are closed. The wand receiving aperture 45 defined in the jaws is aligned with the notch 38 in the lower wall 37 of the support frame so that a wand 12 can project downwardly through the aperture 45 in the jaws and the notch 38. The jaws are each profiled to define a small lip 46 projecting radially inwardly towards the upper end of the wand recess 45a, 45b and are chamfered above the lip 46 to define a seat 47 for receiving the flange 12g of the wand when the jaws are closed. The lips 46 are dimensioned so that the main body portion 12a of the wand can extend downwardly between them when the jaws are closed with the wand flange 12g located within the seat 47 supported on the lips 46 from below. This holds the wand in an operative position. It will be noted that in this arrangement the jaws 35a, 35b completely surround the wand when held in the operative position and the flange 12g of the wand is supported from below over 360 degrees. The jaws 35a, 35b are arranged so that when opened, the flange 12g of the wand is able to pass between the lips 46. Consequently, in use if the jaws 35a, 35b are opened whilst a wand is held in the jaws, the wand 12 will fall between the open jaws and the flange 12g caught on the lip 40b in the notch 38 of the lower support frame portion 34 below, as shown in FIG. 9. This prevents the wand 12 from falling into a beverage container after use and holds the wand loosely in a non-operative position from which it can be conveniently removed by sliding the wand forwardly out through open end of the notch 38.

The opposed inwardly directed surfaces of the jaws 35a, 35b are profiled so that the rear end regions are spaced apart when the jaws are closed and a compression spring 48 is operative between the jaws at their rear ends to bias the jaws to the closed position. Front surfaces of the jaws 35a, 35b are profiled to define a V shaped notch 49 between them. The V shaped notch is 49 configured so that a wand 12 can be inserted between the jaws by pressing the main body 12b of the wand against the jaws in the notch 49 so as to manually force the jaws apart at the front against the bias force of the spring 48. This is illustrated in FIGS. 10 and 11. FIG. 10 shows an upper part of the wand 12 forcing the jaws apart. Once the main body 12a of the wand has passed between the front end regions of the jaws to enter the recessed regions 45a, 45b, the compression spring 48 biases the jaws to the closed position as shown in FIG. 11. The wand 12 is then released by the user and is held in the operative position within the wand aperture 45 defined by the jaws with the flange 12g resting on top of the lips 46 and the main body 12a projecting downwardly through the notch 38 in the lower portion 34a of the supporting frame.

A steam nozzle carrier assembly 50 is slidably mounted to central portion 34c of the support frame for linear movement in a vertical direction relative to the support frame. The steam nozzle 15 is mounted in the carrier 50 and comprises a generally cylindrical member aligned with its longitudinal axis vertical and coincident with the vertical axis of the wand 12 when the wand is mounted in the operative position in the jaws 35a, 35b. The steam nozzle 15 has a steam outlet 51 centrally located at its lower end and a steam inlet 52, which in the present embodiment is located at its upper end. The nozzle defines an internal steam conduit interconnecting the steam inlet 52 with the steam outlet 51. The steam inlet 52 in this embodiment is connected with the streamer by means of a flexible pipe 53, which forms part of the steam conduit 14. The steam nozzle 15 is slidably mounted in a vertical bore 54 in the carrier 50. An outlet region 15a of the steam nozzle at its lower end projects below the carrier 50 and an annular seal 55 is provided on the outlet region surrounding the steam outlet 51. In use, the outlet region 15a of the steam nozzle 15 is brought into engagement with the upper, steam inlet end 12b of the wand when the wand is in the operative position in the jaws so as to engage in the steam inlet 12d and/or in the steam conduit 12f of the wand, with the seal 55 engaging with the wand to prevent steam from escaping between the wand and the steam nozzle. A compression spring 56 is operative between the carrier assembly 50 and the nozzle 15 to bias the nozzle downwardly relative to the carrier to a first, rest position as shown in FIG. 6.

In an alternative embodiment, rather than providing seal 55 on the nozzle a seal could be provided on the wand. This might be provided by means of a resilient surface on a face of the wand which is engaged by the nozzle.

The outlet region 15a of the nozzle is concentric about a vertical axis which is coincident with the axis of the wand steam inlet orifice 12d when the wand is mounted in the jaws in the operative position and the carrier assembly is constrained to move linearly in a vertical direction to bring the nozzle outlet region 15a into engagement with the wand steam inlet 12d. The nozzle steam outlet 51 in this case is a single central orifice concentric about the vertical axis of the outlet region 15a of the nozzle but other outlet arrangements could be used. It will be appreciated that the axes of the outlet region 15a of the nozzle and the wand steam inlet 12d could be offset from the vertical provided the carrier assembly is configured to move the nozzle in a linear direction parallel to the axes to bring the two together. In other embodiments, the movement of the nozzle may be non-linear.

The wand attachment unit 30 has an actuator arrangement 60 for controlling movement of the nozzle carrier assembly 50 relative to the support frame. In the present embodiment, the actuator arrangement includes an electric motor 61 mounted to the support frame and a drive arrangement 62 operatively coupling the motor to the carrier. The drive arrangement 62 includes a vertically extending, linear toothed rack 63 fixedly mounted to or formed integrally with the carrier assembly 50. The motor 61 is positioned with its output shaft aligned horizontally. The shaft carries a pinion gear 64 which is engaged with the toothed rack 63. Rotary movement of the motor output shaft in a first direction causes the carrier 50 to move vertically downwardly relative to the support frame 34 whilst rotary movement of the motor output shaft in a second direction opposite to the first causes the carrier 50 to move vertically upwardly relative to the support frame 34. The carrier 50 is movable under control of the actuator arrangement 60 between a home position, a steam injection position below the home position and a wand ejection position above the home position.

It will be appreciated that other drive arrangements 62 for converting rotary motion of the motor output shaft into linear movement of the nozzle carrier 50 can be adopted. For example, a cam drive arrangement could be used. Indeed, the actuator arrangement 60 need not comprise a motor 61 and drive arrangement 62 but could be of any suitable type of actuator (electronic or otherwise) capable of controlling linear movement of the nozzle carrier 50, such as a linear actuator with an appropriate stroke length, for example.

In the home position as shown in FIG. 6, the steam nozzle 15 and the carrier 50 itself are spaced upwardly from the jaws 35a, 35b so that a wand 12 can be inserted into the jaws as shown in FIGS. 9 and 10. In this configuration, the steam nozzle can be said to be in a wand insertion position. In the steam injection position, which can also be referred to as a wand clamping position, the carrier 50 is lowered from the home position to bring the nozzle 15 into operative engagement with a wand 12 mounted in the jaws as shown in FIG. 7. In this configuration, the steam nozzle can be said to be in a wand engagement position. The system 10 is configured so that the stream nozzle 15 engages the wand 12 before the carrier 50 reaches the end of its travel to the steam injection position. Further movement of the carrier 50 to the steam injection position after the steam nozzle 15 has engaged the wand 12 results in the steam nozzle 15 sliding upwardly relative the carrier 50, compressing the nozzle spring 56. When the carrier 50 reaches the steam injection position, the nozzle 15 will be at a second or wand present position relative to the carrier 50 and is held in contact with the wand by the bias force of the nozzle spring 56. The nozzle spring 56 is operative hold the nozzle 15 in engagement with the wand with a sufficient force to clamp the wand 12 to the lips 46 on the jaws 35a, 35b and to form a good seal between the nozzle seal 55 and the wand 12. In this arrangement, the spring rate of the nozzle spring 56 determines the force with which the nozzle 15 clamps the wand 12 to the jaws. This force is substantially constant each time the nozzle 15 is brought into engagement with the wand, regardless of slight variations in the movement of the carrier 50 which might arise due to tolerances in the drive arrangement and or control of the motor.

Movement of the nozzle 15 to the second position when the carrier 50 is in the steam injection position is indicative that a wand is correctly positioned in the operative position in jaws and the control system 28 includes a sensor arrangement for determining whether this has occurred. The sensor arrangement comprises a Hall effect sensor 65 on a Hall effects board 66 which is mounted in a fixed position on the support frame 34 and a magnet 67 fixedly mounted to the nozzle. When the carrier 50 is in the steam injection position and the nozzle 15 deflected to the second position, the magnet 67 interacts with the Hall effect sensor 65 (otherwise referred to as a “wand present sensor”) and the sensor 65 provides an input to the control system 28. In the event that no wand 12 is mounted in the jaws, the nozzle will not be deflected at all from the first position when the carrier is advanced to the steam injection position so that the wand present senor 65 will not return a wand present signal. Should a wand 12 be incorrectly held in the jaws, the nozzle 15 may be deflected relative to the carrier but by a different amount to that caused by a correctly positioned wand so that the wand present sensor 65 does not return a correct wand present input. For example, if a wand 12 is crookedly mounted in the jaws, the nozzle 15 may be deflected upwardly relative to the carrier 50 beyond the second position.

The control system 28 also includes a sensor arrangement for detecting when the carrier 50 is in the home, steam injection, and wand ejection positions. Conveniently, this sensor arrangement comprises a home position Hall effect sensor 68, a steam injection position Hall effect sensor 69, and a wand ejection position Hall effect sensor 70, all mounted to the Hall effects board at appropriate positions and a magnet 71 mounted to the carrier for interaction with the Hall effect sensors 68, 69, 70. The Hall effects board 66 and the sensors 68, 69, 70 are shown ghosted in FIGS. 7, 9 and 12 and are omitted in FIGS. 6 and 8.

Whilst Hall effect sensors have been found to work well, it will be appreciated that other types of sensor, especially other types of proximity sensor, could be used to detect whether the nozzle 15 is in the second position and/or the position of the carrier 50.

The wand present sensor 65 and the steam injection position sensor 69 provide inputs to the control system 28 so that it can determine that the carrier 50 is in the steam injection position and that a wand 12 is correctly mounted in the jaws before commencing a procedure for introducing steam into the wand through the steam nozzle. Should the carrier 50 be advanced to the steam injection position but no correct wand present signal be provided by the wand present sensor 65, the control system will abort the steaming process.

The wand mounting unit 30 includes a mechanism for automatically locking the jaws 35a, 35b in the closed position when the carrier 50 is in the steam injection position to prevent the wand 12 being inadvertently removed during the steaming process and a wand ejection mechanism for automatically ejecting the wand 12 from the jaws after steaming.

The jaw locking mechanism includes a lock member 72 which depends downwardly from the carrier 50 and is arranged to locate between the inner faces of the jaws 35a, 35 at a position rearward of their pivot axis 43 when the jaws are in the closed position and the carrier has moved from the home position to the steam injection position. The lock member 72 is dimensioned so that when located between the jaws, it is engaged by the inner surfaces of the jaws, preventing the rear end regions of the jaws moving towards each other and so preventing the jaws opening. The length of the lock member 72 is such that it does not engage with the jaws 35a, 35b when the nozzle carrier 50 is in the home position. Accordingly, the jaws can be opened when the carrier is in the home position to insert the wand 12 but are automatically locked in the closed position when the carrier is in the lower, steam injection position so that the jaws cannot be opened whilst steaming is in progress. As an added safety feature, the wand attachment unit 30 includes a steam shield 73 which locates in front of the steam nozzle when it is engaged with the wand to prevent steam being emitted upwardly into the face of a user during steaming.

The wand ejection mechanism includes a wand ejection member 74 which also projects downwardly from the carrier 50 for interaction with the jaws 35a, 35b. The wand ejection member 74 is longer than the lock member 72 and has a wide head region 74a at its distal, lower end which is connected to the carrier by a narrower elongate neck region 74b. The jaws 35a, 35b define corresponding wand ejection recesses 75 on their inner faces at a position between the wand recess 45 and the pivot points 43. The wand ejection member 74 projects through the wand ejection recesses 75 which are dimensioned such that the neck region 74b of the wand ejection member is a sliding fit through the recesses 75 when the jaws are closed. However, the head 74a is wider than the wand ejection recesses 75 so that the head will force the jaws apart to the open position if drawn up between the jaws. The length of the wand ejection member 74 is such that the head portion 74a locates below the jaws when the carrier 50 is in the home position or lower, so that the wand ejection member 74 does not prevent the jaws being fully closed whilst the carrier is in the home or the steam injection positions or anywhere in-between. However, the carrier 50 can be moved by the actuator arrangement 60 to the wand ejection position above the home position in which the head portion 74a is drawn in-between the jaws to force them to the open position against the bias force of the jaw spring 48, as illustrated in FIG. 8. The upper edges of the head portion 74a are profiled so as to progressively spread the jaws as the head portion is drawn in-between the jaws. Once the jaws 35a, 35b have opened sufficiently, the wand 12 falls through the open jaws to be caught on the lip 40b of the notch 38 of the lower wall 37 of the support frame 34b as shown in FIG. 9.

Use of the system 10 to heat and/or froth a beverage will now be described, starting with the device 11 in an initial configuration in which the carrier 50 is in the home position and no wand 12 is mounted in the jaws but the system is otherwise ready.

A user wishing to heat and froth a beverage using the system 10 places the beverage, which may be milk for example, in a container and selects a wand 12. The user places the steam outlet end 12b of the wand 12 in the container, positions the beverage container below the jaws of the wand mounting unit 30 and engages the steam inlet end 12a of the wand in the jaws as illustrated in FIGS. 10 and 11 and as previously described. The system 10 is now ready to commence the steaming processes. The user selects an appropriate user input of the user interface to indicate that steaming is required. In response to the user input, and assuming other system checks are correct, the control system 28 actuates the motor 61 to lower the carrier 50 to the steam injection position so that the nozzle 15 is brought into engagement with the steam inlet 12d of the wand. Once the carrier reaches the steam injection position as indicated by the steam injection position sensor 69, the control system stops the motor 61 and checks for an input from the wand present sensor 65 to confirm that a wand is present. If an input indicative that a wand is correctly mounted in the operative position is received from the wand present senor 65, the control system commences the steaming process by connecting the nozzle to the steamer 13 so that steam is injected into the wand 12 from the steam nozzle 15 and hence into the beverage. At this stage the jaws 35a, 35b are locked in the closed position by the lock member 72. Once the steaming process is complete, the control system 28, disconnects the steam nozzle 15 from the steamer 13 and actuates the motor 61 in a reverse direction to move the carrier 50 from the steam injection position upwardly to the wand ejection position. As the carrier moves upwardly from the steam injection position towards the home position, the lock member 72 is disengaged from the jaws. As the carrier 50 continues upwardly beyond the home position towards the wand ejection position, the head portion 74a of the wand ejection member enters the jaws moving them apart to the open position. As the jaws open, the wand 12 is released and falls onto the lip 40b in the notch 38 of the lower support frame position below. When the control system receives an input from the wand ejection position sensor 76 indicating that the carrier has reached the wand ejection position, it reverses the direction of the motor 61 to move the carrier back to the home position. There may be a short delay where the carrier 50 is held at the wand ejection position before being moved to the home position. When the carrier reaches the home position as indicated by the home position sensor 68, the control system stops the motor 61 and the system may be placed in a standby mode awaiting a further user input. During this process, liquid coffee may be introduced into the beverage through the liquid coffee dispenser 26, which is located adjacent the jaws of the wand attachment unit 30 so as to be located above the beverage container during steaming.

The device 11 may have an indicator, such as a light or sound emitter, to indicate to the user when steaming and any other required processes are complete and the wand has been ejected. The user can then remove the beverage container, sliding the wand 12 out of the notch 18. The wand 12 can be used to stir the beverage if desired and is either dispensed with if it is a disposable wand or subsequently cleaned for reuse.

In the event that a user initiates a steaming cycle with no wand 12 in the operative position or with a wand which is not held in the jaws correctly, the control system 28 will abort the process when the carrier 50 reaches the steam injection position, as indicated by the steam injection position sensor 69, if no input is received from the wand present sensor 65 to indicate that a wand is correctly located in the operative position. In these circumstances, the control system 28 will not connect the steam nozzle to the steamer 13 but instead moves the carrier 50 to the wand ejection position, so that an incorrectly mounted wand is ejected if present, and then back to the home position.

A wand attachment unit 30 similar to that described above can be adopted in a variety of different types of beverage device, including devices in which brewing materials such as coffee are introduced into the machine in a sealed pod which is broken so that the brewing materials are dispensed into a brewing chamber into which hot water is introduced to produce a brewed beverage. FIG. 13 illustrates schematically the fluid components of a further embodiment of a system 110 in accordance with the invention.

The system 110 in accordance with this second embodiment, includes a beverage preparation device 111 having wand attachment unit 130 similar to that described above for removably holding a wand 112 in an operative position and for operatively engaging and disengaging a steam nozzle (not shown in FIG. 13) with a the wand in use.

The system 110 includes a beverage brewing and dispensing sub-system and a steam sub-system for heating and frothing a beverage.

The beverage brewing and dispensing sub-system includes a brewing chamber 123 into which brewing material such as coffee grinds or liquid coffee are dispensed and mixed with hot water. Hot for brewing the beverage is drawn from a cold water reservoir 116 by a main pump 118a, passing through a flow meter 177 and a main water heater 124. After brewing, the extracted beverage is dispensed through a liquid beverage outlet 126 positioned adjacent the wand attachment unit 130.

The steam sub-system includes a smaller water pump 118b which draws cold water from the reservoir 116 passing it through a steamer 113 (which may be a thermoblock). The steamer 113 is connected with a steam nozzle in the wand attachment unit 130 by a steam conduit 114. An air pump 178 is also connected with the steam conduit 114 to enable air to be introduced into the steam line 114 through a one way valve. The steam sub-system includes a steam venting valve 179 in the steam line 114 between the steamer 113 and the nozzle which can be opened to direct excess steam back towards the cold water reservoir. The steam venting valve 179 is typically operated at the end of the steaming process to vent excess steam from the system before the nozzle is disengaged from the wand. This helps to prevent excess steam escaping between the wand and the nozzle as the nozzle carrier is raised. The steam venting valve 179 is an electronically actuated valve which is operated by the electronic control system 28.

In use, once a user has inserted a wand 112 in the operative position within a container 109 holding a beverage such as milk, the system 110 is used to heat and froth the beverage by directing steam through the wand in the manner described above in relation to the first embodiment. Depending on the procedure requested by the user, the device 111 may first brew a beverage using the beverage brewing and dispensing sub-system whilst the nozzle carrier is in the home position, with the brewed beverage being dispensed into the milk before the steaming process is commenced.

In the embodiments described above, the device has an electronically actuated venting valve 179 for selectively connecting the steamer 113 with the steam nozzle 15 or with a suitable waste location such as the cold water reservoir 16, 116. The control system 28 will actuate the valve to connect the steamer 113 to the steam nozzle 15 when a steaming procedure has been selected and the sensors confirm that the nozzle carrier is in the steam injection position and a wand is present in the operative position and will actuate the valve to disconnect the steamer from the steam nozzle and connect it to the reservoir at the end of the steaming procedure to release any excess steam pressure before the nozzle carrier is raised to disconnect the nozzle 15 from the wand 12.

Rather than using an electronic steam venting valve, a mechanical valve arrangement can be incorporated into the steam nozzle engagement mechanism 32.

FIGS. 14 to 19 illustrate an alternative embodiment of a wand attachment unit 130 for use in the device 111 according to the second embodiment illustrated in FIG. 13. The wand attachment unit 130 is similar to that of the first embodiment to which the reader should refer for details as only the major differences between the wand attachment unit 130 according to this further embodiment and the wand attachment unit 30 of the first embodiment will be described in detail. These differences are mainly in the steam nozzle engagement mechanism 132, which is modified to incorporate a mechanical valve arrangement 180 which replaces the electronic steam venting valve 179 and is also operative to direct hot water from the main water heater 124 to the brewing chamber 123.

The nozzle carrier 150 has a body 181 defining a vertical bore 154 in which the steam nozzle 115 is slidably mounted. The body 181 in this case comprises a valve body and defines three ports 182, 183, 184 which all open into the bore 154 at different vertical positions. A first port 182 is an inlet port which is fluidly connected selectively with either the steamer 113 or a source of hot water, such as the main water heater 124. A second port 183 opens into the bore 154 above the inlet port and is a venting port fluidly connected with a dump, which may be the cold water reservoir 116 or part of the fluid circuit between the cold water reservoir 116 and the steamer 113. The third port 184 is located below the inlet port 182 and provides an outlet port for hot water fluidly connected with the brewing chamber 123.

The steam nozzle 115 is a generally cylindrical member slidably mounted in the bore 154. The nozzle has a central region 186 having a diameter smaller than that of the bore 154 whilst regions 187, 188 of the nozzle above and below the central region are a close sliding fit within the bore 154. An upper end region of the nozzle projects out of the carrier body 181 and a spring collar 189 is fixedly mounted to the upper end region of the nozzle outside of the carrier body 181. A coil spring 156 is mounted in tension between the spring collar 189 and the carrier body 181 and is operative to bias the nozzle downwardly within the bore relative to the carrier body 181 to the first, rest position. As with the previous embodiment, the nozzle 115 has a steam outlet 151 located centrally at its lower end for directing steam into a wand in use. However, the nozzle steam inlet 152 in this embodiment is provided by a radial port which opens into the bore 154 towards the lower end of the smaller diameter region of the nozzle. The radial port 152 is fluidly connected with the steam outlet 151 by means internal steam conduit 190 within the nozzle.

Three seals 191, 192, 193 are mounted about the smaller dimeter central region of the nozzle for engagement with a surface of the bore 154 so as to fluidly isolate regions of the bore above and below each seal from one another. The seals are spaced apart from one another and positioned so that the inlet port 182 is fluidly connected to either the venting port 183, the hot water outlet port 184, or the steam inlet 152 of the nozzle, depending on the vertical position of the nozzle 115 within the bore 154. An uppermost one of the seals 191 is located at the upper end of the narrow diameter region of the nozzle and positioned so as to locate between the inlet port 182 and the venting port 183 when the steam nozzle 115 is in the first position. A further one of the seals 192 is located just above the steam inlet 152 of the nozzle and is configured to locate below the hot water outlet port 184 when the nozzle is in the first position. The other, lowermost one of the seals 193 is located at the lower end of the narrow diameter portion, below the radial steam inlet port 152 of the nozzle.

FIG. 14 shows the carrier 150 in the home position with the nozzle 115 being held in the first position relative to the carrier body 181 of the carrier by the nozzle spring 156. In this configuration, the uppermost seal 191 is located between the inlet port 182 and the venting port 183 and the middle seal 192 is located below the hot water outlet port 184 so that the inlet port 182 is fluidly connected with the hot water outlet port 184 through the bore 154 between the uppermost seal 191 and the middle seal 192 but fluidly isolated from both the venting port 183 and the steam inlet port 152 in the nozzle. Flow through the valve 180 when the nozzle is in the first, rest position is shown in FIG. 17. In this configuration, hot water can be directed through the valve 180 to the brewing chamber 123 by connecting the inlet port 182 to the main water heater 124. Typically, hot water is only directed through the valve 180 to the hot water outlet when the home position Hall effect sensor 68 indicates that the carrier 150 is in the home position.

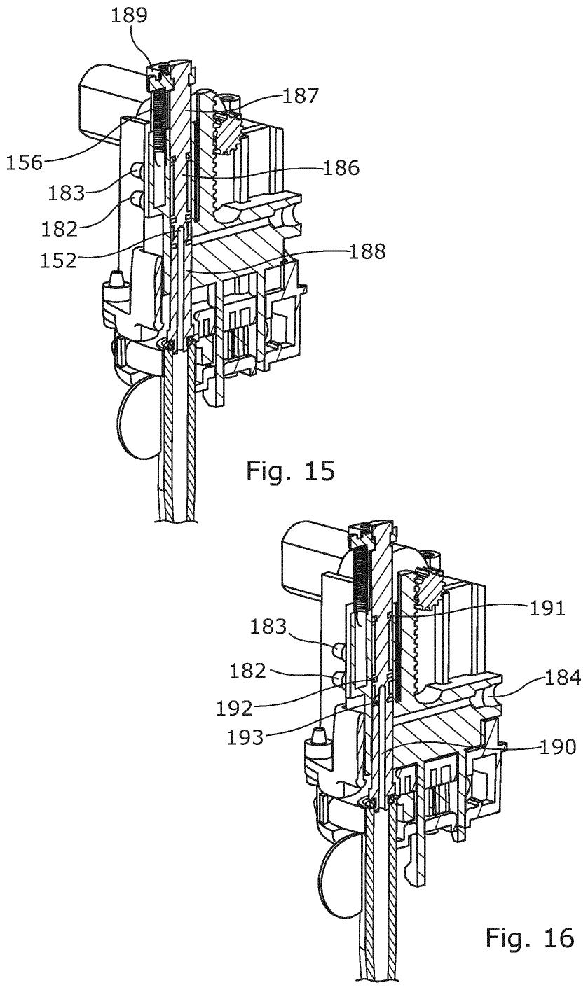

During movement of the carrier 150 from the home position towards the steam injection position but before the nozzle 115 has engaged the wand 12, the inlet port 182 remains fluidly connected with the hot water outlet port 184 through the valve 180. As the carrier 150 approaches the steam injection position, the nozzle 115 engages the wand and is deflected upwardly relative to the carrier body 181, expanding the nozzle spring 156. As illustrated in FIG. 15, this initially moves the nozzle 115 to an intermediate or venting position within the carrier body 150 in which the uppermost seal 191 is located above the venting port 183 and the middle seal 192 is located above the hot water outlet port 184 so that the inlet port 182 is fluidly connected with the venting port 183 but is fluidly isolated from the hot water outlet port 184 and the steam inlet 152 of the nozzle. This allows hot water and/or steam to vent from within the valve and the inlet port if there is an excess pressure build up. Flow through the valve 180 with the nozzle in the venting position is shown in FIG. 18.

As the nozzle carrier 150 continues downwardly to the steam injection position as shown in FIG. 16, the nozzle 115 is moved past the venting position to the second position within the bore 154. Once the nozzle 115 is in the second position, the middle seal 192 above the nozzle steam inlet 152 is positioned between the inlet port 182 and the venting port 183 and the lowermost seal 193 below the nozzle steam inlet 152 is positioned below the inlet port 182 but above the hot water outlet port 184. This places the inlet port 182 in fluid communication with the steam inlet 152 of the nozzle 115. In this configuration, the steaming process can be carried out, with steam directed through the inlet port 182 and the nozzle 115 into the wand 112. Flow through the valve 180 with the nozzle in the second position is shown in FIG. 19.

Once the steaming process is complete, the control system 28 will stop directing steam into the inlet port 182 of the valve and move the carrier 150 towards the wand eject position. As the carrier 150 beings to move away from the wand, the nozzle 115 is biased downwardly towards the first position by the nozzle spring 156 and will pass again through the intermediate venting position in which the inlet port 182 is fluidly connected with the venting port 183 as illustrated in FIGS. 15 and 18. This occurs before the nozzle fully disengages the wand and allows any remaining steam in the inlet port 182 and valve 180 to be safely vented, ensuring that no steam or hot water is vented externally toward the user when the nozzle 115 subsequently disengages from the wand.

The nozzle carrier 150 will continue to move first to the wand ejection position and then back to the rest position. Once the carrier 150 has moved away from the wand by a sufficient distance, the nozzle 115 will be fully disengaged from the wand and returned to the first position by the nozzle spring 156 so that the inlet port 182 is fluidly connected with the hot water outlet port 184 as illustrated in FIG. 17. However, the control system 28 does not actuate the hot water system to deliver hot water through the valve 180 to the hot water outlet unless sensors 68, 70 indicate that the carrier 150 has returned to the home position, having passed through the wand ejection position, and hot water is required.

Incorporating a mechanical valve arrangement 180 into the steam nozzle engagement mechanism 132 conveniently makes use of the linear displacement of the nozzle carrier and the nozzle to selectively direct steam through the nozzle 115 to the wand or to a vent at the appropriate times without the need to incorporate an electronically actuated valve. In the present embodiment, the valve 180 is also used to selectively direct hot water and/or steam to a brew chamber but the valve could be modified so that it is only used to connect the steam source to the nozzle or to a vent. It will be appreciated that the details of the valve arrangement can be varied from those in the embodiment disclosed whilst still achieving the function of using movement of the nozzle 115 relative to a valve body as it engages and disengage with a wand to direct steam and/or hot water to appropriate targets within the system. Any two or more of the seals 191, 192, 193 could be provided as separate sealing faces on a single seal member or they may all be entirely separate seal members.

Many variations are possible without departing from the scope of the invention. For example, a wand mounting unit 30, 130 similar to those described herein can be adopted in a variety of different types of beverage device and are not limited to application in a beverage preparation device as shown in FIG. 1. Furthermore, whilst a pair of spring loaded jaws 35a, 35b for holding the wand in the operative position has been found to be particularly effective, the wand attachment unit may comprise other arrangements for holding the wand in the operative position. In a further modification, rather than mounting the steam nozzle in a carrier assembly, the steam nozzle itself may be directly moved between the wand insertion position in which it is spaced from the wand holder to permit the wand to be inserted into or removed from the wand holder and the wand engagement position in which it operatively engages with an inlet end of the wand when mounted in the wand holder in the operative position. In such an embodiment, the actuator arrangement would be arranged to act directly on the steam nozzle to move it between the wand insertion and wand engagement positions and to any other positions required under control of the control system.

1: A system for heating and frothing a beverage, said system comprising a device for preparing a beverage and a wand removably mountable to the device, the device having a wand holder in which the wand is removably mountable to hold the wand in an operative position and a steam nozzle operably connectable with a source of steam, wherein the steam nozzle is movable between a wand insertion position in which it is spaced from the wand holder to permit the wand to be inserted into or removed from the wand holder and a wand engagement position in which it operatively engages with an inlet end of the wand when mounted in the wand holder in the operative position, the device including an actuator arrangement operative to move the steam nozzle between said wand insertion and wand engagement positions and a control system for regulating actuation of the actuator arrangement.

2: A system as claimed in claim 1, wherein the steam nozzle is mounted in a carrier assembly which is movable between a home position and a steam injection position, wherein the steam nozzle is held in the wand insertion position when the carrier assembly is in the home position and the steam nozzle adopts the wand engagement position when the carrier assembly is in the steam injection position and the wand is mounted in the in wand holder in the operative position.

3: A system as claimed in claim 2, wherein the steam nozzle is movably mounted in the carrier assembly and resiliently biased to a first position relative to the carrier assembly, the arrangement being configured such that, in use with the wand held in the wand holder, the steam nozzle engages the inlet end of the wand before the carrier assembly reaches the end of its travel from the home position to the steam injection position, continued movement of the carrier assembly to the steam injection position resulting in displacement of the steam nozzle relative to the carrier assembly from the first position to a second position against the resilient bias force.

4: A system as claimed in claim 3, wherein the arrangement is configured such that the resilient bias holds the steam nozzle in engagement with the wand with a predetermined force in use.

5: A system as claimed in claim 3, wherein the device comprises a sensor arrangement for detecting displacement of the steam nozzle from the first position to the second position when the carrier assembly is in the steam injection position.

6: A system as claimed in claim 2, wherein the wand defines a steam inlet orifice concentric about an axis, the carrier assembly being constrained to move in a linear direction parallel to the direction of said axis when the wand is mounted in the wand holder in the operative position.

7: A system as claimed in claim 1, wherein the wand has an elongate main body and a flange extending radially outwardly from the main body, the wand holder being configured to support the flange from below when the wand is held in the wand holder, the steam nozzle being operative to clamp the wand flange to the wand holder when it operatively engages the wand in the wand holder.

8: A system as clamed in claim 7, wherein the wand holder comprises a pair of jaws movable between a closed position and an open position, the jaws in the closed position defining an aperture between themselves through which the main body of the wand can pass and an upwardly directed support surface at least partially surrounding the aperture for supporting the flange of the wand from below, the jaws in the open position being spaced apart sufficiently that the flange of the wand can pass between them, the jaws being biased to the closed position.

9: A system as claimed in claim 8, wherein the jaws have opposed first end regions located at an outer position accessible by a user and profiled such that, in use, a wand can be inserted into the holder by pressing the body of the wand between the opposed first end regions to cause the jaws to open against the bias force sufficiently to allow the body of the wand to pass between the end regions to enter regions of the jaws that define the aperture.

10: A system as claimed in claim 1, wherein the device comprises a locking mechanism operative to lock the jaws in the closed position when the steam nozzle is in operative engagement with a wand held in the wand holder in the operative position.

11: A system as claimed in claim 1, the device comprising a wand ejector for ejecting the wand from the wand holder.

12: A system as claimed in claim 11, wherein the device comprises a formation for catching the wand and retaining it in a non-operative position when the wand is ejected from the wand holder.

13: A system as claimed in claim 1, the device having a valve for regulating the flow of steam from the steam source to an outlet of the steam nozzle, wherein the device is configured such that the valve is operative to permit steam to flow from the steam source to the outlet of the steam nozzle only when the nozzle is in operative engagement with a wand is mounted in the operative position in the wand holder.

14: A system as claimed in claim 13, wherein the steam nozzle is movably mounted in the carrier assembly and resiliently biased to a first position relative to the carrier assembly, the arrangement being configured such that, in use with the wand held in the wand holder, the steam nozzle engages the inlet end of the wand before the carrier assembly reaches the end of its travel from the home position to the steam injection position, continued movement of the carrier assembly to the steam injection position resulting in displacement of the steam nozzle relative to the carrier assembly from the first position to a second position against the resilient bias force; and wherein the steam nozzle is slidably mounted in a bore defined in a valve body forming part of the carrier assembly for movement between said first and second positions, the valve body defining an inlet port opening into the bore and fluidly connectable with the steam source, the nozzle defining a steam inlet fluidly connected with the steam outlet by a steam passage, the nozzle steam inlet opening into the bore, wherein the arrangement is configured such that the nozzle steam inlet is fluidly connected with the inlet port through the valve body bore when the steam nozzle is in the second position but is fluidly isolated from the inlet port when the steam nozzle is in the first position.

15: A system as claimed in claim 14, wherein the nozzle has a region with a diameter smaller than the internal diameter of the bore in the valve body, the nozzle steam inlet being defined in said smaller diameter region of the nozzle, the nozzle carrying a first seal located above the nozzle steam inlet and a second seal located below the nozzle steam inlet, each of the first and second seals slidably engaging a surface of the bore, the arrangement being configured such that when the nozzle is in said second position, the first seal locates above the inlet port and the second seal locates below the inlet port so that the nozzle steam inlet is fluidly connected with the inlet port through the bore between the first and second seals.

16: A system as claimed in claim 14, wherein the valve body further defines a venting outlet port which opens into the bore, the arrangement being configured such that the inlet port is fluidly connected with the venting outlet port through the bore when the nozzle is at an intermediate position between the first and second positions.

17: A system as claimed in claim 15, wherein the valve body further defines a venting outlet port which opens into the bore, the arrangement being configured such that the inlet port is fluidly connected with the venting outlet port through the bore when the nozzle is at an intermediate position between the first and second positions; and wherein the venting port opens into the bore at a position above the inlet port, the nozzle carrying a third seal for engagement with the bore which is located above the first seal, wherein the arrangement is configured such that in use when the nozzle is in the first position, the third seal locates between the inlet port and the venting port to fluidly isolate the inlet and venting ports from one another and when the nozzle is in said intermediate position, the third seal locates above the venting port and the first seal locates below the inlet port so that the inlet port and the venting port are fluidly connected through the bore between the first and third seals.

18: A system as claimed in claim 14, wherein the valve body further defines a hot water outlet port which opens into the bore, the arrangement being configured such that the inlet port is fluidly connected with the hot water outlet port through the valve body bore when the nozzle is in the first position.

19: A system as claimed in claim 17, wherein the valve body further defines a hot water outlet port which opens into the bore, the arrangement being configured such that the inlet port is fluidly connected with the hot water outlet port through the valve body bore when the nozzle is in the first position, and wherein the hot water outlet port opens into the bore below the inlet port, the arrangement being configured such that in use:
a. when the nozzle is in the first position, the first seal locates below the hot water outlet port so that the inlet port and the hot water outlet port are fluidly connected through the bore between the first and third seals; and,
b. when the nozzle is in said intermediate position, the first seal is positioned between the inlet port and the hot water outlet port to fluidly isolate the inlet port from the hot water outlet port and the third seal locates above the venting port so that the inlet port is fluidly connected with the venting port through the bore between the first and third seals; and,
c. when the nozzle is in said second position, the second seal locates between the inlet port and the hot water outlet port so that the inlet port and the hot water outlet port are fluidly isolated from one another.

20: A system for heating and frothing a beverage, said system comprising a device for preparing a beverage and a wand removably mountable to the device, the device having a wand holder in which the wand is removably mountable to hold the wand in an operative position and a steam nozzle operably connectable with a source of steam, wherein the steam nozzle is movable between a wand insertion position in which it is spaced from the wand holder to permit the wand to be inserted into or removed from the wand holder and a wand engagement position in which it operatively engages with an inlet end of the wand when the wand is mounted in the wand holder in the operative position, wherein the steam nozzle is mounted in a bore of a valve body for movement between a first position and a second position relative to the valve body, the arrangement being such that in use, the nozzle adopts the first position relative to the valve body when in the wand insertion position and adopts the second position relative to the valve body when operatively engaged with a wand held in the wand holder in the operative position, the valve body defining an inlet port opening into the bore and fluidly connectable with the steam source, the nozzle defining a steam inlet and a steam outlet fluidly connected by a steam passage, the nozzle steam inlet opening into the bore, the arrangement being configured such that the nozzle steam inlet is fluidly connected with the inlet port through the bore when the steam nozzle is in the second position but is fluidly isolated from the inlet port when the steam nozzle is in the first position.

21: A system as claimed in claim 20, wherein, the nozzle has a region with a diameter smaller than the internal diameter of the bore in the valve body, the nozzle steam inlet being defined in said smaller diameter region of the nozzle, the nozzle carrying a first seal located above the nozzle steam inlet and a second seal located below the nozzle steam inlet, each of the first and second seals slidably engaging a surface of the bore, the arrangement being configured such that when the nozzle is in said second position, the first seal locates above the inlet port and the second seal locates below the inlet port so that the nozzle steam inlet is fluidly connected with the inlet port through the bore between the first and second seals and when the nozzle is in the first position, one of the first and second seals engages the bore between the inlet port and the nozzle steam inlet such that the inlet port and the nozzle steam inlet are fluidly isolated from one another.

22: A system as claimed in claim 20, wherein the valve body further defines a venting outlet port which opens into the bore, the arrangement being configured such that the inlet port is fluidly connected with the venting outlet port through the bore when the nozzle is at an intermediate position between the first and second positions.

23: A system as claimed in claim 21, wherein the valve body further defines a venting outlet port which opens into the bore, the arrangement being configured such that the inlet port is fluidly connected with the venting outlet port through the bore when the nozzle is at an intermediate position between the first and second positions, and wherein the venting outlet port opens into the bore at a position spaced from the inlet port, the nozzle carrying a third seal slidingly engaging with the surface of the bore and which is spaced from the first and second seals, wherein the arrangement is configured such that in use when the nozzle is in the first position, the third seal locates between the inlet port and the venting outlet port to fluidly isolate the inlet and venting ports from one another and when the nozzle is in said intermediate position, the third seal locates on one side of the venting outlet port and the first and second seals locate on the opposite side of the inlet port from the venting outlet port so that the inlet port and the venting outlet port are fluidly connected through the bore.

24: A system as claimed in claim 20, wherein the valve body defines a hot water outlet port which opens into the bore, the arrangement being configured such that the inlet port is fluidly connected with the hot water outlet port through the valve body bore when the nozzle is in the first position.

25: A system as claimed in claim 23, wherein the valve body defines a hot water outlet port which opens into the bore, the arrangement being configured such that the inlet port is fluidly connected with the hot water outlet port through the valve body bore when the nozzle is in the first position, and wherein the hot water outlet port opens into the bore at a position spaced from the inlet port, the arrangement being configured such that in use:
a. when the nozzle is in the first position, the first, second and third seals are positioned to define a flow path through the bore from the inlet port to the hot water outlet port, whilst fluidly isolating the inlet port from the nozzle steam inlet and the venting port; and
b. when the nozzle is in said intermediate position, the seals are positioned to define a flow path through the bore from the inlet port to the venting outlet port, whilst fluidly isolating the inlet port from the nozzle steam inlet and the hot water outlet port; and,
c. when the nozzle is in said second position, the first and second seals locate either side of the inlet port such that a flow path is defined through the bore from the inlet port to the nozzle steam inlet between the first and second seals, whilst the first and second seals are operative to fluidly isolate the inlet port from the venting outlet port and the hot water outlet port.
